(19) United States
(12) Patent Application Publication
(10) Pub. No.: US 2011/0121710 A1
(43) Pub. Date: May 26, 2011

(54) LAMP AND ILLUMINATING DEVICE

(75) Inventors: Lung Chen, HsinChu (TW); Hui-Hsiang Feng, HsinChu (TW); Ya-Chuan Yeh, HsinChu (TW); Jian-Lung Chen, HsinChu (TW)

(73) Assignee: Arclite Optronics Corp.

(21) Appl. No.: 12/757,892

(22) Filed: Apr. 9, 2010

(30) Foreign Application Priority Data
Nov. 20, 2009 (TW) 098221748

(51) Int. Cl. H01J 1/02; H01J 5/16

(52) U.S. Cl. 313/113; 313/357

(57) ABSTRACT

A lamp includes a tube, a first inner electrode and a second inner electrode. The tube has a cavity, a first sealed portion and a second sealed portion. The cavity is located between the first and the second sealed portions. The first and the second inner electrodes are disposed at the first and the second sealed portions respectively and extend into the cavity. The first inner electrode has a first rod and a first head portion disposed at a first end of the first rod and located within the cavity. A volume of the first head portion is between 1.0 and 30 mm³. The second inner electrode has a second rod and a second head portion disposed at a second end of the second rod and located within the cavity. A volume of the second head portion is between 0.1 and 4.0 mm³.

### CROSS-REFERENCES

This application claims priority to Taiwan application No. 098221748 filed on Nov. 20, 2009.

### BACKGROUND

1. Field of the Invention

The present invention relates to a lamp and in particular, to an illuminating device having the lamp.

2. Detailed Description of the Related Art

FIG. 1 is a schematic cross-sectional view of a conventional illuminating device. Referring to FIG. 1, the conventional illuminating device 100 includes a reflector 110, a lamp 120, a first conductive contact 130 and a second conductive contact 140. The reflector 110 has an opening 112 and a foundation 114 opposite to the opening 112. The lamp 120 is fixed to the foundation 114 and at least partially disposed in the reflector 110. The lamp 120 has a first electrode 122 and a second electrode 124 which are opposite to each other and spaced apart with an interval. The first electrode 122 is disposed in the reflector 110 and adjacent to the opening 112 and the second electrode 124 is disposed at the foundation 114.

The first conductive contact 130 is disposed at a right side of the reflector 110 and located outside the reflector 110. The first conductive contact 130 is adjacent to the opening 112. The first electrode 122 is electrically connected to the first conductive contact 130 by means of a wire 150 passing through the interior of the reflector 110. The second conductive contact 140 is disposed at a left side of the reflector 110 and located outside the reflector 110. The second conductive contact 140 is adjacent to the opening 112. The second electrode 124 is electrically connected to the second conductive contact 140 by means of a wire 160 passing through the exterior of the reflector 110.

The first electrode 122 includes a first inner electrode 122a having a first head portion H11 disposed in a cavity 126 of the lamp 120. The second electrode 124 includes a second inner electrode 124a having a second head portion H12 disposed in the cavity 126 of the lamp 120.

When the first conductive contact 130 and the second conductive contact 140 of the illuminating device 100 are designed to be connected to an alternating current (AC) power source, the size and the shape of the first head portion H11 are designed to be equal to those of the second head portion H12, respectively. When the first conductive contact 130 and the second conductive contact 140 of the illuminating device 100 are designed to be connected to a direct current (DC) power source, the size and the shape of the first head portion H11 are designed to be unequal to those of the second head portion H12, respectively and the volume of the first head portion H11 is larger than that of the second head portion H12. Accordingly, a manufacturer must fabricate different lamps in accordance to the kinds of the power source such that the production efficiency of the lamps can not be improved and the production cost of the lamps can not be reduced.

### BRIEF SUMMARY

The present invention is directed to provide a lamp adapted to be connected to an AC power source or a DC power source.

The present invention is further directed to provide an illuminating device of which the lamp is adapted to be connected to an AC power source or a DC power source.

The present invention provides a lamp adapted to be connected to an external power source. The external power source is a DC power source or an AC power source. The lamp includes a tube, a first inner electrode and a second inner electrode. The tube has a cavity, a first sealed portion and a second sealed portion. The cavity is located between the first sealed portion and the second sealed portion. The first inner electrode is disposed at the first sealed portion and extends into the cavity. The first inner electrode has a first rod and a first head portion. The first head portion is disposed at a first end of the first rod and located in the cavity. A volume of the first head portion is between 1.0 and 30 cubic millimeter. A length of the first head portion is between 1.0 and 5.0 millimeters. A maximum thickness of the first head portion is between 0.5 and 3.0 millimeters. A maximum thickness of the first rod is between 0.2 and 1.0 millimeters. The second inner electrode is disposed at the second sealed portion and extends into the cavity. The second inner electrode has a second rod and a second head portion. The second head portion is disposed at a second end of the second rod and located in the cavity. A volume of the second head portion is between 0.1 and 4.0 cubic millimeter. A length of the second head portion is between 0.55 and 3.08 millimeters. A maximum thickness of the second head portion is between 0.2 and 2.1 millimeters. A maximum thickness of the second rod is between 0.15 and 0.75 millimeters. The first head portion and the second head portion are spaced apart with an interval.

In an embodiment of the present invention, the first head portion includes a first base portion and a first electrode tip. The first base portion is disposed between the first electrode tip and the first end. A maximum thickness of the first electrode tip is smaller than or equal to a minimum thickness of the first base portion. A maximum thickness of the first base portion is the maximum thickness of the first head portion.

In an embodiment of the present invention, the second head portion includes a second base portion and a second electrode tip. The second base portion is disposed between the second electrode tip and the second end. A maximum thickness of the second electrode tip is smaller than or equal to a minimum thickness of the second base portion. A maximum thickness of the second base portion is the maximum thickness of the second head portion.

In an embodiment of the present invention, the volume of the first head portion is larger than the volume of the second head portion.

In an embodiment of the present invention, the maximum thickness of the first head portion is larger than the maximum thickness of the first rod.

In an embodiment of the present invention, the maximum thickness of the second head portion is larger than the maximum thickness of the second rod.

In an embodiment of the present invention, the maximum thickness of the first head portion is larger than the maximum thickness of the second head portion.

In an embodiment of the present invention, the length of the first head portion is larger than the length of the second head portion.

The present invention provides an illuminating device including a reflector and the lamp. The reflector has an opening and a foundation opposite to the opening. The lamp is fixed to the foundation and at least partially disposed in the reflector.

The volume of the first head portion is between 1.0 and 30 cubic millimeter and the length of the first head portion is between 1.0 and 5.0 millimeters. The maximum thickness of the first head portion is between 0.5 and 3.0 millimeters and the maximum thickness of the first rod is between 0.2 and 1.0 millimeters. In addition, the volume of the second head portion is between 0.1 and 4.0 cubic millimeter and the length of the second head portion is between 0.55 and 3.08 millimeters. The maximum thickness of the second head portion is between 0.2 and 2.1 millimeters and the maximum thickness of the second rod is between 0.15 and 0.75 millimeters. Accordingly, the lamp of the illuminating device of the embodiment of the present invention can be adapted to be connected to the DC power source or the AC power source in accordance with a designer's requirement. According to the mentioned above, the production efficiency of the lamp of the embodiment of the present invention can be improved and the production cost of the lamp can be reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic cross-sectional view of a conventional illuminating device.

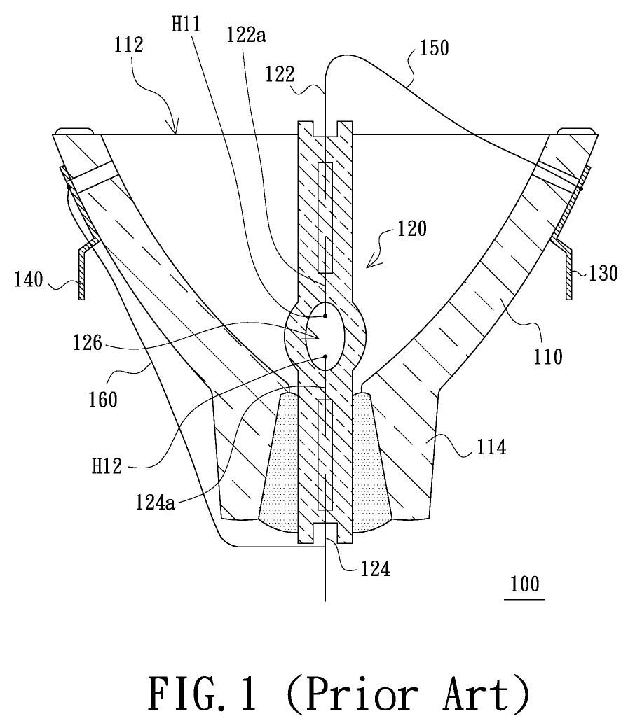

FIG. 2A is a schematic cross-sectional view of an illuminating device of a first embodiment of the present invention.

FIG. 2B is a schematic enlarged view of the first inner electrode of FIG. 2A.

FIG. 2C is a schematic enlarged view of the second inner electrode of FIG. 2A.

FIG. 3 is a schematic view of the second inner electrode of a second embodiment of the present invention.

FIG. 4 is a schematic view of the second inner electrode of a third embodiment of the present invention.

FIG. 5 is a schematic view of the second inner electrode of a fourth embodiment of the present invention.

FIG. 6 is a schematic view of the second inner electrode of a fifth embodiment of the present invention.

### DETAILED DESCRIPTION

Reference will now be made to the drawings to describe exemplary embodiments of the present sensing system, in detail. The following description is given by way of example, and not limitation.

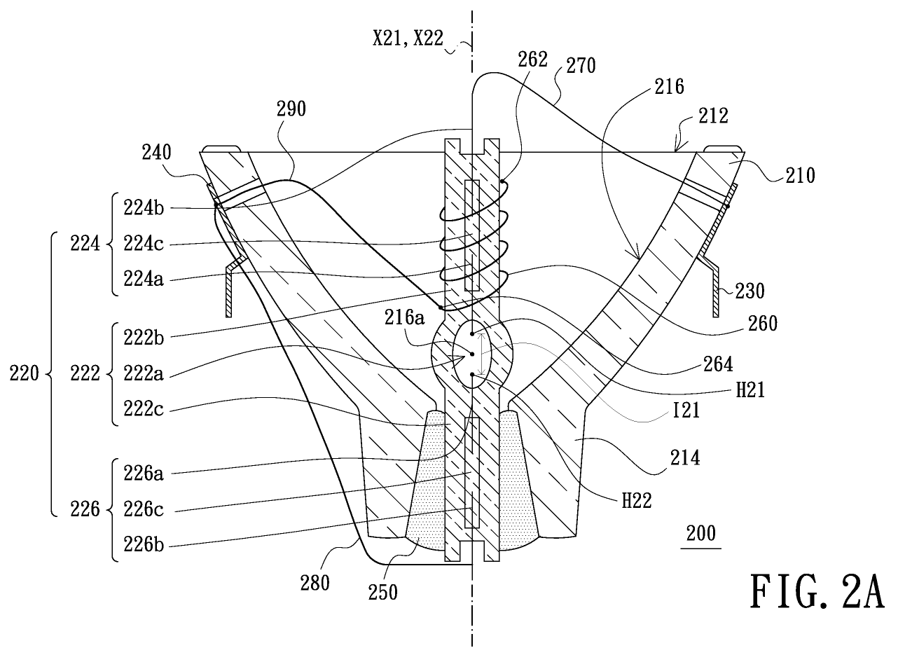

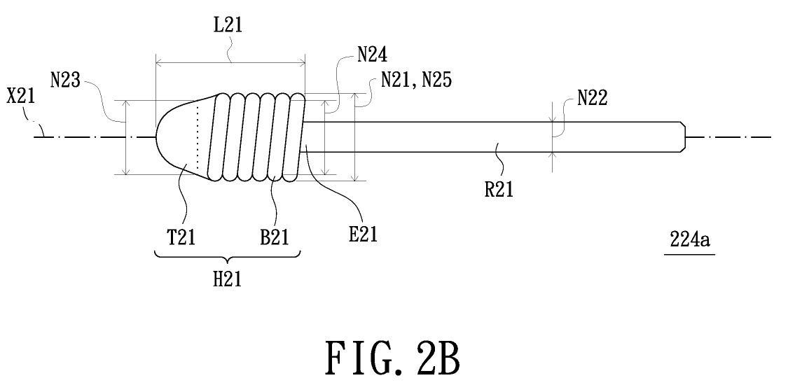

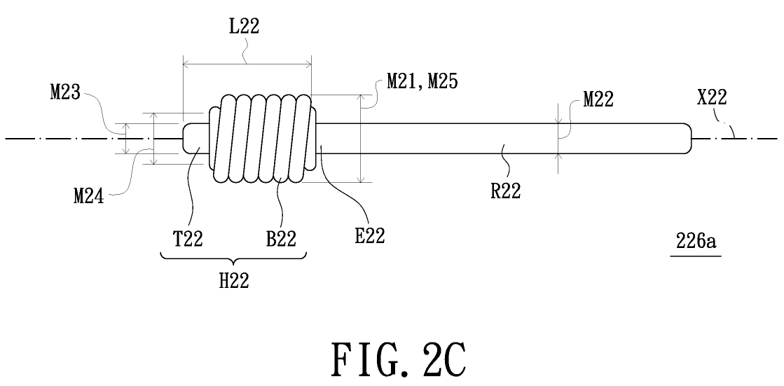

FIG. 2A is a schematic cross-sectional view of an illuminating device of a first embodiment of the present invention. FIG. 2B is a schematic enlarged view of the first inner electrode of FIG. 2A. FIG. 2C is a schematic enlarged view of the second inner electrode of FIG. 2A. Referring to FIGS. 2A, 2B and 2C, an illuminating device 200 of the present embodiment includes a reflector 210, a lamp 220, a first conductive contact 230, a second conductive contact 240, a cement 250, a conductive coil 260 and a plurality of wires 270, 280 and 290. The lamp 220 is located in the reflector 210. The first conductive contact 230 and the second conductive contact 240 are disposed at the reflector 210. The lamp 220 is connected to an external power source (not shown) by means of the first conductive contact 230 and the second conductive contact 240. The external power source is a DC power source or an AC power source.

The reflector 210 has an opening 212 and a foundation 214. The foundation 214 is opposite to the opening 212 and foundation 214 is, for example, a hollow neck-shaped structure. An inner surface 216 of the reflector 210 is a reflective surface which may be a paraboloid. In addition, the material of the reflector 200 may include glass, ceramic, metal or plastic. The reflector 210 can reflect light generated by the lamp 220 so that the light generated by the lamp 220 is emitted to the outside of the reflector 210 through the opening 212.

The lamp 220 is, for example, a gas discharge lamp which is fixed to the foundation 214 of the reflector 210 and at least partially disposed in the reflector 210. The lamp 220 includes a tube 222, a first electrode 224 and a second electrode 226. The tube 222 includes a cavity 222a, a first sealed portion 222b and a second sealed portion 222c opposite to the first sealed portion 222b. The cavity 222a is located between the first sealed portion 222b and the second sealed portion 222c. The second sealed portion 222c is disposed at foundation 214 through the cement 250 and the first sealed portion 222b is adjacent to the opening 212 of the reflector 210. The cavity 222a of the present embodiment is filled with a filler which can be ionized and may be mercury gas or noble gas. In addition, the material of the tube 222 may be quartz glass.

The first electrode 224 is disposed at the first sealed portion 222b and extends into the cavity 222a and outside the tube 222. Concretely, the first electrode 224 includes a first inner electrode 224a, a first outer electrode 224b and a first electrode-connecting member 224c. The first inner electrode 224a is disposed at the first sealed portion 222b and extends into the cavity 222a. The first inner electrode 224a has a first rod R21 and a first head portion H21. The first head portion H21 includes a first base portion B21 and a first electrode tip T21. The first rod R21 has a first end E21 located in the cavity 222a. The first head portion H21 is disposed at the first end E21 of the first rod R21 and located in the cavity 222a. The first base portion B21 is disposed between the first electrode tip T21 and the first end E21.

The volume of the first head portion H21 is between 1.0 and 30 cubic millimeter. A length L21 of the first head portion H21 along the extension axis X21 of the first rod R21 is between 1.0 and 5.0 millimeters. A maximum thickness N21 of the first head portion H21 perpendicular to the extension axis X21 is between 0.5 and 3.0 millimeters. A maximum thickness N22 of the first rod R21 perpendicular to the extension axis X21 is between 0.2 and 1.0 millimeters. In the embodiment, the maximum thickness N21 of the first head portion H21 is larger than the maximum thickness N22 of the first rod R21.

It should be noted that a maximum thickness N23 of the first electrode tip T21 perpendicular to the extension axis X21 is smaller than or equal to a minimum thickness N24 of the first base portion B21 perpendicular to the extension axis X21. In the embodiment, the maximum thickness N23 of the first electrode tip T21 is equal to the minimum thickness N24 of the first base portion B21. In addition, a maximum thickness N25 of the first base portion B21 perpendicular to the extension axis X21 is the maximum thickness N21 of the first head portion H21. It should be noted that the shape of the first head portion H21 of the embodiment is merely an example and not intended to limit the present invention.

The first outer electrode 224b is disposed at the first sealed portion 222b and extends outside the tube 222 and the first outer electrode 224b is adjacent to the opening 212 of the reflector 210. The first electrode-connecting member 224c is disposed in the first sealed portion 222b and connects the first inner electrode 224a and the first outer electrode 224b. The material of the first inner electrode 224a of the present embodiment may be tungsten, the material of the first outer electrode 224b may be molybdenum or tantalum and the material of the first electrode-connecting member 224c may be molybdenum.

The second electrode 226 is disposed at the second sealed portion 222c and extends into the cavity 222a and outside the tube 222. Concretely, the second electrode 226 includes a second inner electrode 226a, a second outer electrode 226b and a second electrode-connecting member 226c. The second inner electrode 226a is disposed at the second sealed portion 222c and extends into the cavity 222a. The second inner electrode 226a has a second rod R22 and a second head portion H22. The second head portion H22 includes a second base portion B22 and a second electrode tip T22. The second rod R22 has a second end E22 located in the cavity 222a. The second head portion H22 is disposed at the second end E22 of the second rod R22 and located in the cavity 222a. The second base portion B22 is disposed between the second electrode tip T22 and the second end E22.

The volume of the second head portion H22 is between 0.1 and 4.0 cubic millimeter. A length L22 of the second head portion H22 along the extension axis X22 of the second rod R22 is between 0.55 and 3.08 millimeters. A maximum thickness M21 of the second head portion H22 perpendicular the extension axis X22 is between 0.2 and 2.1 millimeters. A maximum thickness M22 of the second rod R22 perpendicular the extension axis X22 is between 0.15 and 0.75 millimeters. In the embodiment, the maximum thickness M21 of the second head portion H22 is larger than the maximum thickness M22 of the second rod R22. The volume of the first head portion H21 is larger than the volume of the second head portion H22. The maximum thickness N21 of the first head portion H21 is larger than the maximum thickness M21 of the second head portion H22. The length L21 of the first head portion H21 is larger than the length L22 of the second head portion H22.

In addition, the first head portion H21 and the second head portion H22 are spaced apart with an interval 121 along the extension axis X21 (or the extension axis X22). A midpoint of the interval I21 is located at a focus point 216a of the inner surface 216 such as a paraboloid.

It should be noted that a maximum thickness M23 of the second electrode tip T22 perpendicular the extension axis X22 is smaller than or equal to a minimum thickness M24 of the second base portion B22 perpendicular the extension axis X22. In the embodiment, the maximum thickness M23 of the second electrode tip T22 is smaller than the minimum thickness M24 of the second base portion B22. In addition, the maximum thickness M25 of the second base portion B22 perpendicular the extension axis X22 is the maximum thickness M21 of the second head portion H22. It should be noted that the shape of the second head portion H22 of the embodiment is merely an example and not intended to limit the present invention.

The second outer electrode 226b is disposed at the second sealed portion 222c and extends outside the tube 222. The second electrode-connecting member 226c is disposed in the second sealed portion 222c and connects the second inner electrode 226a and the second outer electrode 226b. The material of the second inner electrode 226a of the present embodiment may be tungsten, the material of the second outer electrode 226b may be molybdenum or tantalum and the material of the second electrode-connecting member 226c may be molybdenum.

The first conductive contact 230 is disposed at a right side of the reflector 210 and located outside the reflector 210. The first outer electrode 224b is electrically connected to the first conductive contact 230 through a wire 270 passing through the interior of the reflector 210. In the embodiment, the first conductive contact 230 is adjacent to the opening 212 of the reflector 210.

The second conductive contact 240 is disposed at a left side of the reflector 210 and located outside the reflector 210. The second outer electrode 226b is electrically connected to the second conductive contact 240 through a wire 280 passing outside the reflector 210. In the embodiment, the second conductive contact 240 is adjacent to the opening 212 of the reflector 210.

In addition, the conductive coil 260 is disposed around the first sealed portion 222b of the tube 222 and includes a free end 262 and a connecting end 264. The connecting end 264 is electrically connected to the second conductive contact 240 through a wire 290 passing through the interior of the reflector 210. When the illuminating device 200 is activated, the conductive coil 260 electrified generates an electric field around the first electrode 224 such that the starting voltage of the illuminating device 200 of the present embodiment is reduced.

The volume of the first head portion H21 is between 1.0 and 30 cubic millimeter and the length L21 of the first head portion H21 is between 1.0 and 5.0 millimeters. The maximum thickness N21 of the first head portion H21 is between 0.5 and 3.0 millimeters and the maximum thickness N22 of the first rod R21 is between 0.2 and 1.0 millimeters. In addition, the volume of the second head portion H2 is between 0.1 and 4.0 cubic millimeter and the length L22 of the second head portion H22 is between 0.55 and 3.08 millimeters. The maximum thickness M21 of the second head portion H22 is between 0.2 and 2.1 millimeters and the maximum thickness M22 of the second rod R22 is between 0.15 and 0.75 millimeters. Accordingly, the lamp 220 of the illuminating device 200 of the embodiment of the present invention can be adapted to be connected to the DC power source or the AC power source in accordance with a designer's requirement. As the mentioned above, the production efficiency of the lamp 220 of the embodiment of the present invention can be improved and the production cost of the lamp 200 can be reduced.

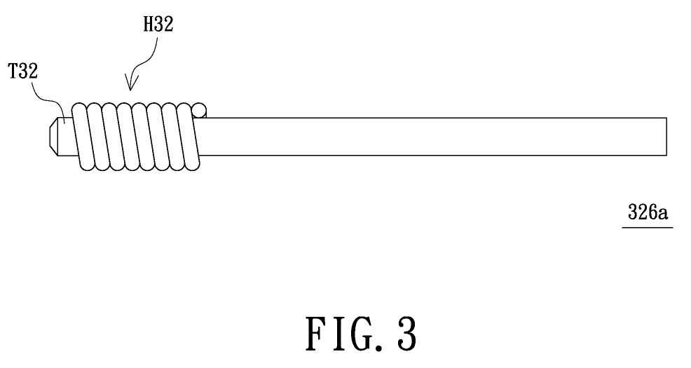

FIG. 3 is a schematic view of the second inner electrode of a second embodiment of the present invention. Referring to FIG. 3, the shape of the second electrode tip T32 of the second head portion H32 of the second inner electrode 326a of the present embodiment is different from that of the second electrode tip T22 of the second head portion H22 of the second inner electrode 226a of the first embodiment.

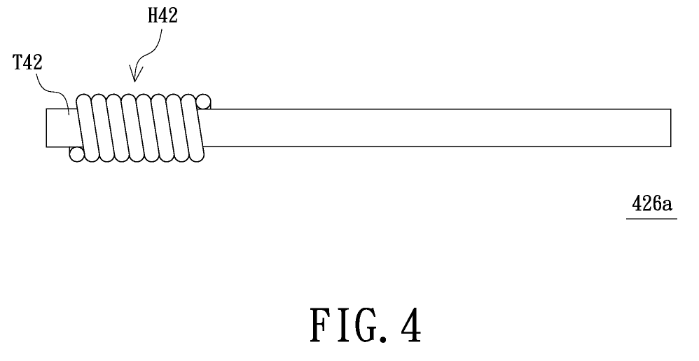

FIG. 4 is a schematic view of the second inner electrode of a third embodiment of the present invention. Referring to FIG. 4, the shape of the second electrode tip T42 of the second head portion H42 of the second inner electrode 426a of the present embodiment is different from that of the second electrode tip T22 of the second head portion H22 of the second inner electrode 226a of the first embodiment.

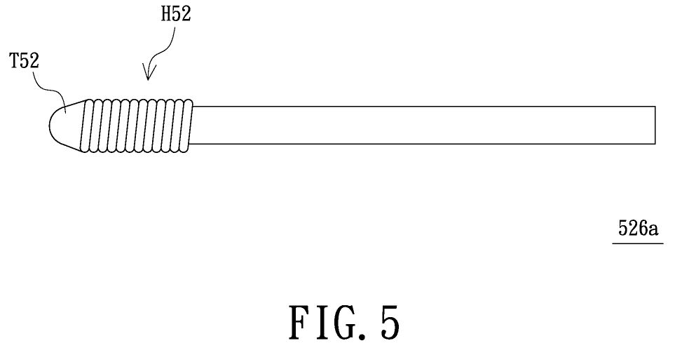

FIG. 5 is a schematic view of the second inner electrode of a fourth embodiment of the present invention. Referring to FIG. 5, the shape of the second electrode tip T52 of the second head portion H52 of the second inner electrode 526a of the present embodiment is different from that of the second electrode tip T22 of the second head portion H22 of the second inner electrode 226a of the first embodiment.

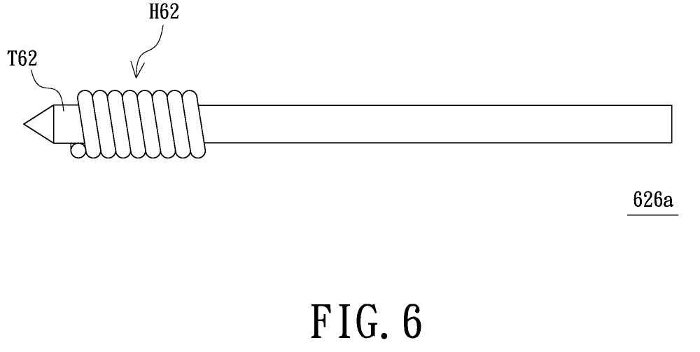

FIG. 6 is a schematic view of the second inner electrode of a fifth embodiment of the present invention. Referring to FIG. 6, the shape of the second electrode tip T62 of the second head portion H62 of the second inner electrode 626a of the present embodiment is different from that of the second electrode tip T22 of the second head portion H22 of the second inner electrode 226a of the first embodiment.

According to the mentioned above, the lamp and the illuminating device of the embodiment of the present invention have at least one of the following or other advantages. The volume of the first head portion is between 1.0 and 30 cubic millimeter and the length of the first head portion is between 1.0 and 5.0 millimeters. the maximum thickness of the first head portion is between 0.5 and 3.0 millimeters and the maximum thickness of the first rod is between 0.2 and 1.0 millimeters. In addition, the volume of the second head portion is between 0.1 and 4.0 cubic millimeter and the length of the second head portion is between 0.55 and 3.08 millimeters. The maximum thickness of the second head portion is between 0.2 and 2.1 millimeters and the maximum thickness of the second rod is between 0.15 and 0.75 millimeters. Accordingly, the lamp of the illuminating device of the embodiment of the present invention can be adapted to be connected to the DC power source or the AC power source in accordance with a designer's requirement. According to the mentioned above, the production efficiency of the lamp of the embodiment of the present invention can be improved and the production cost of the lamp can be reduced.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A lamp adapted to be connected to an external power source which is a DC power source or an AC power source, comprising:
a tube having a cavity, a first sealed portion and a second sealed portion, wherein the cavity is located between the first sealed portion and the second sealed portion;
a first inner electrode disposed at the first sealed portion and extending into the cavity, wherein the first inner electrode has a first rod and a first head portion, the first head portion is disposed at a first end of the first rod and located in the cavity, a volume of the first head portion is between 1.0 and 30 cubic millimeter, a length of the first head portion is between 1.0 and 5.0 millimeters, a maximum thickness of the first head portion is between 0.5 and 3.0 millimeters, and a maximum thickness of the first rod is between 0.2 and 1.0 millimeters; and
a second inner electrode disposed at the second sealed portion and extending into the cavity, wherein the second inner electrode has a second rod and a second head portion, the second head portion is disposed at a second end of the second rod and located in the cavity, a volume of the second head portion is between 0.1 and 4.0 cubic millimeter, a length of the second head portion is between 0.55 and 3.08 millimeters, a maximum thickness of the second head portion is between 0.2 and 2.1 millimeters, a maximum thickness of the second rod is between 0.15 and 0.75 millimeters, and the first head portion and the second head portion are spaced apart with an interval.

2. The lamp as claimed in claim 1, wherein the first head portion includes a first base portion and a first electrode tip, the first base portion is disposed between the first electrode tip and the first end, a maximum thickness of the first electrode tip is smaller than or equal to a minimum thickness of the first base portion, and a maximum thickness of the first base portion is the maximum thickness of the first head portion.

3. The lamp as claimed in claim 1, wherein the second head portion includes a second base portion and a second electrode tip, the second base portion is disposed between the second electrode tip and the second end, a maximum thickness of the second electrode tip is smaller than or equal to a minimum thickness of the second base portion, and a maximum thickness of the second base portion is the maximum thickness of the second head portion.

4. The lamp as claimed in claim 1, wherein the volume of the first head portion is larger than the volume of the second head portion.

5. The lamp as claimed in claim 1, wherein the maximum thickness of the first head portion is larger than the maximum thickness of the first rod.

6. The lamp as claimed in claim 1, wherein the maximum thickness of the second head portion is larger than the maximum thickness of the second rod.

7. The lamp as claimed in claim 1, wherein the maximum thickness of the first head portion is larger than the maximum thickness of the second head portion.

8. The lamp as claimed in claim 1, wherein the length of the first head portion is larger than the length of the second head portion.

9. An illuminating device adapted to be connected to an external power source which is a DC power source or an AC power source, comprising:
a reflector having an opening and a foundation opposite to the opening;
a lamp fixed to the foundation and at least partially disposed in the reflector, wherein the lamp is adapted to be connected to the external power source, the lamp comprises:
a tube having a cavity, a first sealed portion and a second sealed portion, wherein the cavity is located between the first sealed portion and the second sealed portion, and the first sealed portion or the second sealed portion is disposed at the foundation;
a first inner electrode disposed at the first sealed portion and extending into the cavity, wherein the first inner electrode has a first rod and a first head portion, the first head portion is disposed at a first end of the first rod and located in the cavity, a volume of the first head portion is between 1.0 and 30 cubic millimeter, a length of the first head portion is between 1.0 and 5.0 millimeters, a maximum thickness of the first head portion is between 0.5 and 3.0 millimeters, and a maximum thickness of the first rod is between 0.2 and 1.0 millimeters; and
a second inner electrode disposed at the second sealed portion and extending into the cavity, wherein the second inner electrode has a second rod and a second head portion, the second head portion is disposed at a second end of the second rod and located in the cavity, a volume of the second head portion is between 0.1 and 4.0 cubic millimeter, a length of the second head portion is between 0.55 and 3.08 millimeters, a maximum thickness of the second head portion is between 0.2 and 2.1 millimeters, a maximum thickness of the second rod is between 0.15 and 0.75 millimeters, and the first head portion and the second head portion are spaced apart with a interval.

10. The illuminating device as claimed in claim 9, wherein the first head portion includes a first base portion and a first electrode tip, the first base portion is disposed between the first electrode tip and the first end, a maximum thickness of the first electrode tip is smaller than or equal to a minimum thickness of the first base portion, and a maximum thickness of the first base portion is the maximum thickness of the first head portion.

11. The illuminating device as claimed in claim 9, wherein the second head portion includes a second base portion and a second electrode tip, the second base portion is disposed between the second electrode tip and the second end, a maximum thickness of the second electrode tip is smaller than or equal to a minimum thickness of the second base portion, and a maximum thickness of the second base portion is the maximum thickness of the second head portion.

12. The illuminating device as claimed in claim 9, wherein the volume of the first head portion is larger than the volume of the second head portion.

13. The illuminating device as claimed in claim 9, wherein the maximum thickness of the first head portion is larger than the maximum thickness of the first rod.

14. The illuminating device as claimed in claim 9, wherein the maximum thickness of the second head portion is larger than the maximum thickness of the second rod.

15. The illuminating device as claimed in claim 9, wherein the maximum thickness of the first head portion is larger than the maximum thickness of the second head portion.

16. The illuminating device as claimed in claim 9, wherein the length of the first head portion is larger than the length of the second head portion.
